(19) United States
(12) Patent Application Publication
(10) Pub. No.: US 2011/0041997 A1
(43) Pub. Date: Feb. 24, 2011

(54) Speed Change Kit For An Absorent Article Converting Line

(76) Inventors: James Jay Benner, Morrow, OH (US); Eric Peters Stockl, Deerfield Twp, OH (US); Jose Mauricio Berrizbeitia, Deerfield Twp, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/544,346

(22) Filed: Aug. 20, 2009

(51) Int. Cl. B32B 37/12

(52) U.S. Cl. 156/269; 156/459; 156/536

(57) ABSTRACT

The present disclosure relates to speed change kits adapted to allow converting lines to be reconfigured to operate at different speeds. In one form, a system for fabricating disposable absorbent articles includes a plurality of converting modules; a plurality of absorbent article converting mechanisms; and a speed kit. The plurality of absorbent article converting mechanisms can be configured from a first configuration to a second configuration by modifying the plurality of absorbent article converting mechanisms to include the speed kit. In the first configuration, the plurality of absorbent article converting mechanisms operate to produce absorbent articles at a first speed range; and when in the second configuration, the plurality of absorbent article converting mechanisms operate to produce absorbent articles at a second speed range different from the first speed range.

### FIELD OF THE INVENTION

The present disclosure relates to converting lines for manufacturing absorbent articles, and more particularly, to speed change kits including various systems adapted to allow a converting line to be reconfigured to operate at a different speed.

### BACKGROUND OF THE INVENTION

Disposable, reusable and durable products such as diapers, adult incontinence articles, feminine hygiene tampons, sanitary napkins, underpants, shirts, shorts, swimsuits, gowns, pants, coats, gloves, scarves, surgical drapes, bibs, blankets, sheets, pillow cases, etc. may be manufactured on high speed converting lines. A converting line may utilize a web-based carrier to which many source materials, whether in a continuous web or discrete pieces, are processed and/or attached to the web to create a finished product.

Although a converting line may allow for high speed production, some converting lines may be inflexible in that line changes are time consuming and expensive. In some instances, converting lines are custom designed and built to make specific products within a narrow range of parameters and operating conditions to include a relatively narrow range of speeds tailored to meet the specific needs of a particular business in the most cost effective way. For example, some converting lines are designed for low cost and/or low production throughput to match local capital cost affordability needs that are typical of low income markets in third world countries, or limited production requirements for the products produced that are typical in new or developing markets where consumer demand is still not mature. In other examples, converting lines may be custom designed for high speed and the high production throughput of product. The technical requirements for these lines are typically very demanding with the most sophisticated equipment and technologies being used to achieve high performance. Such lines may be used in well established, mature markets and/or high income markets in first world countries where such high performance need is a good match with business needs and where the capital cost is relatively affordable. Yet other converting lines are designed and built to produce products for markets that are in between the low cost, low production requirement markets and the high cost, high production requirement markets. Such lines may use more advanced technology than the low cost, low speed lines, but may not be as sophisticated as the high cost, high speed lines in order to bring the proper balance of cost, production throughput, performance and technology to meet the specific needs of markets between the extremes mentioned above.

In light of the aforementioned scenarios, if a manufacturer wants to enter a new or low income market, it may be preferable to do so with a low speed, low cost converting line tailored to the modest needs of the market. If the manufacturer installs a low cost, low speed converting line initially, the manufacturer may need to add converting lines to meet the demand as the market matures or demand for the product increases. As such, the manufacturer may be faced with a dilemma as to what type of converting line to use to meet the increased demand. The manufacturer face the dilemma having to choose from the options of purchasing additional low cost, low speed lines; replacing the existing lower speed lines with high speed lines; or purchasing high speed lines to augment the existing low speed lines. As production needs grow in such expanding markets, none of the aforementioned equipment investment options may be ideal for sustaining the business. The purchase option of buying additional low cost, low speed lines to augment the original equipment can often be an on-going, inefficient and costly approach due to the potential need for many more converting lines requiring excessive space, additional support utilities, and additional operating crews. The option of replacing the low cost, low speed lines with new high speed lines may also not be ideal since the manufacturer may be faced with the need to recapitalize their business, and either scrap the original low speed lines that often have residual asset value or relocate the low speed lines at a significant cost. The third option to purchase high speed lines to augment the original low cost, low speed lines may also not be attractive due to the creation of significant production inefficiencies and additional on-going costs to support and upgrade the product on multiple platforms. In an attempt to avoid such a dilemma, the manufacturer may initially decide to enter the low income market with a high cost, high speed line to make products. However, the manufacturer may face a significant barrier for to enter the market due to the high business risk or unaffordable capital and fixed operating costs versus sales income.

The above situations highlight a need to have converting lines with the flexibility to operate over a broad range of speeds in a cost effective way to help manufacturers efficiently expand manufacturing capability to meet increase demand in various markets.

### SUMMARY OF THE INVENTION

The present disclosure relates to speed change kits adapted to allow converting lines to be reconfigured to operate at different speeds. In one form, a system for fabricating disposable absorbent articles includes: a plurality of converting modules, each converting module defining an interior space; a plurality of absorbent article converting mechanisms, each converting mechanism arrange in the interior space of each converting module; and a speed kit; wherein the plurality of absorbent article converting mechanisms can be configured from a first configuration to a second configuration by modifying the plurality of absorbent article converting mechanisms to include the speed kit; wherein in the first configuration, the plurality of absorbent article converting mechanisms operate to produce absorbent articles at a first speed range; and wherein in the second configuration, the plurality of absorbent article converting mechanisms operate to produce absorbent articles at a second speed range different from the first speed range.

In another form, a system for fabricating disposable absorbent articles includes: a plurality of converting modules, each converting module defining an interior space; a plurality of absorbent article converting mechanisms, each converting mechanism disposed in the interior space of each converting module; wherein the plurality of absorbent article converting mechanisms can be configured from a first configuration to a second configuration by modifying the plurality of absorbent article converting mechanisms to include a speed kit. The speed kit includes: at least one material delivery system selected from the group consisting of: a hot melt glue system, a particle feed system; and a web delivery system; at least one web handling system selected from the group consisting of: a vacuum conveyor, a web idler, a web guider, and a scrap product conveyor; at least one process transformation apparatus selected from the group consisting of: a folding device, a stretch activation unit, a cut and slip unit, a discrete component applicator, a cutting device, and a bonding unit; at least one utility system selected from the group consisting of: a noise abatement enclosure, a vacuum fan, a vacuum pump, and a chilling unit; and wherein in the first configuration, the plurality of absorbent article converting mechanisms operate to produce absorbent articles at a first speed range; and wherein in the second configuration, the plurality of absorbent article converting mechanisms operate to produce absorbent articles at a second speed range different from the first speed range.

In yet another form, a method of reconfiguring a converting line adapted to operate at a first speed range to operate at a second speed range different from the first speed range, wherein the first speed range is defined by a first minimum speed and a first maximum speed greater than the first minimum speed and wherein the second speed range is defined by a second minimum speed and a second maximum speed greater than the second minimum speed, includes the steps of: removing at least one of a first material delivery system, a first web handling system, a first process transformation apparatus, and a utility system from the converting line; and installing at least one of a second material delivery system, a second web handling system, a second process transformation apparatus, and a second utility system on the converting line, wherein the second material delivery system is selected from the group consisting of: a hot melt glue system, an AGM feed system; and a web delivery system; wherein the second web handling system is selected from the group consisting of: a vacuum conveyor, a web idler, a web guider, and a scrap product conveyor; wherein the second process transformation apparatus is selected from the group consisting of: a folding device, a stretch activation unit, a cut and slip unit, a discrete component applicator, a cutting device, and a bonding unit; and wherein the second utility system is selected from the group consisting of: a noise abatement enclosure, a vacuum fan, a vacuum pump, and a chilling unit.

### BRIEF DESCRIPTION OF THE DRAWINGS

FIG. 1 is a front side view of a converting line in a low speed configuration.

FIG. 2 is a front perspective view of the converting line of FIG. 1.

FIG. 3 is a perspective view of a high speed conversion kit.

FIG. 4 is a front side view of the converting line of FIG. 1 in a high speed configuration.

FIG. 5 is a front perspective view of the converting line of FIG. 4.

FIG. 6 is a perspective view of a low speed conversion kit.

### DETAILED DESCRIPTION OF THE INVENTION

The following term explanations may be useful in understanding the present disclosure: “Absorbent article” is used herein to refer to consumer products whose primary function is to absorb and retain soils and wastes. “Diaper” is used herein to refer to an absorbent article generally worn by infants and incontinent persons about the lower torso. The term “disposable” is used herein to describe absorbent articles which generally are not intended to be laundered or otherwise restored or reused as an absorbent article (e.g., they are intended to be discarded after a single use and may also be configured to be recycled, composted or otherwise disposed of in an environmentally compatible manner).

The term “disposed” is used herein to mean that an element(s) is formed (joined and positioned) in a particular place or position as a macro-unitary structure with other elements or as a separate element joined to another element.

As used herein, the term “joined” encompasses configurations whereby an element is directly secured to another element by affixing the element directly to the other element, and configurations whereby an element is indirectly secured to another element by affixing the element to intermediate member(s) which in turn are affixed to the other element.

The term “substrate” is used herein to describe a material which is primarily two-dimensional (i.e. in an XY plane) and whose thickness (in a Z direction) is relatively small (i.e. 1/10 or less) in comparison to its length (in an X direction) and width (in a Y direction). Non-limiting examples of substrates include a layer or layers or fibrous materials, films and foils such as plastic films or metallic foils that may be used alone or laminated to one or more web, layer, film and/or foil. As such, a web is a substrate.

The term “nonwoven” refers herein to a material made from continuous (long) filaments (fibers) and/or discontinuous (short) filaments (fibers) by processes such as spunbonding, meltblowing, and the like. Nonwovens do not have a woven or knitted filament pattern.

The term “machine direction” (MD) is used herein to refer to the direction of material flow through a process. The term “cross direction” (CD) is used herein to refer to a direction that is generally perpendicular to the machine direction.

The present disclosure relates to converting lines for manufacturing absorbent articles, and speed change kits adapted to allow converting lines to be reconfigured to operate at different speeds. An absorbent article converter line may include a combination of converting mechanisms that move substrates and component materials through a manufacturing process. While advancing in the machine direction MD through the converting line, substrates may be combined with the other substrates and/or discrete components to create a continuous length of absorbent articles. Various substrates can be used to construct various components of the absorbent articles, such as backsheets, topsheets, and absorbent cores. Exemplary descriptions of absorbent article components are provided in U.S. Pat. Nos. 3,860,003; 5,151,092; 5,554,145; 5,569,234; 5,580,411; and 6,004,306, which are all incorporated by reference herein. At a downstream portion of the converting process, the continuous length of absorbent articles may be subjected to a final knife and cut to create separate and discrete absorbent articles. In addition, defective articles may be removed from the process by a rejection system. Articles that are not deemed to be defective may be subject to further processing steps, such as folding and packaging.

The operating speed of a converting line may be defined in various ways so as to relate to a rate of production to meet a particular business demand for the product made. In some instances, the operating speed of a converting line may defined by the number of articles produced over a period of time. For example, the operating speed of a converting line may be defined in units of articles or pads per minute. In some instances, the operating speed may be defined by the rate at which one or more substrates travel through converting line in the machine direction. For example, the operating speed of a converting line may be defined in units of meters per second.

The converting lines herein include the capability of being configured to operate across a broad range of speeds. As discussed in more detail below, the converting lines include a common architecture having a broad speed range capability. The converting line architecture may include a plurality of process equipment converting modules connected with each other along a machine direction (MD). Each converting module defines an interior space and may house an absorbent article converting mechanism therein. The converting modules and/or converting mechanisms may be configured with many base supporting systems and components having the ability to operate across a broad speed range. The converting modules and/or converting mechanisms may also be configured with some targeted high cost, speed-sensitive systems and/or components having the ability to operate in a relatively narrow speed range. A pre-determined speed kit may include targeted speed systems and/or components that having the ability to operate in a different relatively narrow speed range. As such, installation of a speed change kit may allow the converting line to efficiently operate relatively low or high speeds without having to completely replace the converting line. Such a configuration may allow for the management of a common standard converting line platform with optional pre-determined speed kits to run at different speed ranges with equipment designed to match the required line performance needs of a particular business at the most effective capital cost.

In one example scenario, a converting line may include converting modules and/or converting mechanisms configured with systems and components having the ability to operate at relatively high and low speeds. The converting modules and/or converting mechanisms may also be configured with a low speed kit including replaceable low speed systems and/or components specifically designed to operate at a relatively low speed range at a lower capital cost. As such, the entire converting line is limited to operating at the relatively low speed range. If desired, the converting line may be reconfigured to operate a relatively high speed range by investing in and installing a high speed change kit. Such a high speed change kit may include a systems and/or components specifically designed to operate at the relatively high speed range. For example, the pre-determined high speed kit may include high-cost, speed-sensitive unit operations and tooling, and possibly, raw material or component delivery systems. Installation of the high speed kit on the converting line allows the converting line to operate at the relatively high speed. More particularly, the low speed kit including the replaceable low speed components and/or systems may be removed and replaced with the high speed systems and/or components from the high speed kit. As such, a converting line configured with a low speed kit may be provided to deliver a low speed, low capital cost solution for initial new or low income market production needs. The low speed kit can be disconnected and exchanged with a high speed kit having components performing the same functions as the low speed kit, but at a production rate significantly above the lower production rate.

The aforementioned capability may allow manufactures to enter new or low income markets with a low cost, low speed variant of the converting line to start producing products to match the local low cost affordability limits and/or limited production requirements. As market demand for the product matures and grows, and the affordable capital cost increases with the higher product sales, further investment in the converting line could be justified. The high speed kit could then be installed to replace the low speed equipment, allowing the converting line to achieve the desired speed level and match the market production requirements while still remaining cost affordable.

It is to be appreciated that the speed kits according to the present disclosure can include various combinations of systems and components, depending on the particular configuration of the converting line and associated converting modules and/or converting mechanisms. For example, in one embodiment, the speed kit may include one or more of: a material delivery system; a web handling system; a process transformation apparatus; and a utility system. It is to be appreciated that each system or apparatus of a speed change kit may have various configurations. For example, a material delivery system may include various different types of systems, such as a hot melt glue system; a particle feed system; and/or a web delivery system, such as a web unwind.

Examples of such systems for low speed applications may include an ITW Dynatec S-Series hot melt gluing system operating in pressure-feed mode, or an Azo volumetric particle dosing system for AGM. In another example, a web handling system may include one or more of a vacuum conveyor; a web idler; a web guider; and/or a scrap product conveyor. Examples of such systems may include Frameccanica Data's FA-X Special converter low speed aluminum shell web idlers, and flat belt vacuum transport conveyors. In yet another example, a process transformation apparatus may include one or more of a folding device; a stretch activation unit; a cut and slip unit; a discrete component applicator; a cutting device; and/or a bonding unit. Examples of such systems may include Frameccanica Data's FA-X Special converter low speed cuff folding board without glycol chilling capability, and low speed cut and slip unit. In still another example, a utility system may include one or more of a noise abatement enclosure; a vacuum fan; a vacuum pump; and a chilling unit. Examples of such systems may include low capacity vacuum fan from Ferrari Fan and Frameccanica Data's FA-X Special converter low speed noise abatement guarding enclosure.

Examples of comparable systems for high speed applications may include an ITW Dynatec M-Series hot melt gluing system operating in metered mode, and an Azo discharge weighing particle dosing system for AGM. In another example, a web handling system may include one or more of a vacuum conveyor; a web idler; a web guider; and/or a scrap product conveyor. Examples of such systems may include Frameccanica Data's FA-X Premium converter high speed carbon fiber shell web idlers, and timing belt vacuum transport conveyors. In yet another example, a process transformation apparatus may include one or more of a folding device; a stretch activation unit; a cut and slip unit; a discrete component applicator; a cutting device; and/or a bonding unit. Examples of such systems may include Frameccanica Data's FA-X Special converter high speed cuff folding board with glycol chilling capability, and high speed cut and slip unit. In still another example, a utility system may include one or more of a noise abatement enclosure; a vacuum fan; a vacuum pump; and a chilling unit. Examples of such systems may include high capacity vacuum fan from Ferrari Fan and/or Frameccanica Data's FA-X Premium converter high speed noise abatement guarding enclosure.

Although the present disclosure is provided in the context of manufacturing absorbent articles, and diapers in particular, it is to be appreciated that the systems and methods disclosed herein may be applied to converting lines used to manufacture of various types of articles and products. Examples of other products include absorbent articles for inanimate surfaces such as consumer products whose primary function is to absorb and retain soils and wastes that may be solid or liquid and which are removed from inanimate surfaces such as floors, objects, furniture and the like. Non-limiting examples of absorbent articles for inanimate surfaces include dusting sheets such as the SWIFFER cleaning sheets, pre-moistened wipes or pads such as the SWIFFER WET pre-moistened cloths, paper towels such as the BOUNTY paper towels, dryer sheets such as the BOUNCE dryer sheets and dry-cleaning clothes such as the DRYEL cleaning clothes all sold by The Procter & Gamble Company. Additional examples of products include absorbent articles for animate surfaces whose primary function is to absorb and contain body exudates and, more specifically, devices which are placed against or in proximity to the body of the user to absorb and contain the various exudates discharged from the body. Non-limiting examples of incontinent absorbent articles include diapers such as PAMPERS diapers, training and pull-on pants such as PAMPERS FEEL 'N LEARN and EASY UPS, adult incontinence briefs and undergarments such as ATTENDS adult incontinence garments, feminine hygiene garments such as panty liners, absorbent inserts, and the like such as ALWAYS and TAMPAX, toilet paper such as CHARMIN toilet paper, tissue paper such as PUFFS tissue paper, facial wipes or clothes such as OLAY DAILY FACIAL wipes or clothes, toilet training wipes such as KANDOO pre-moistened wipes, all sold by The Procter & Gamble Company. Still other examples of products include packaging components and substrates and/or containers for laundry detergent and coffee, which may be produced in pellets or pouches and may be manufactured in a converting or web process or even discreet products produced at high speed such as high-speed bottling lines, cosmetics, razor blade cartridges, and disposable consumer batteries.

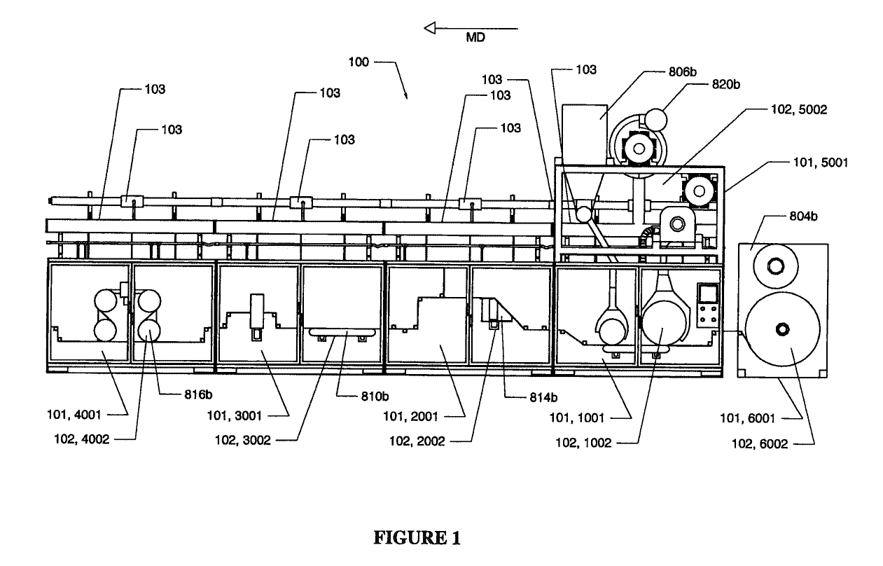

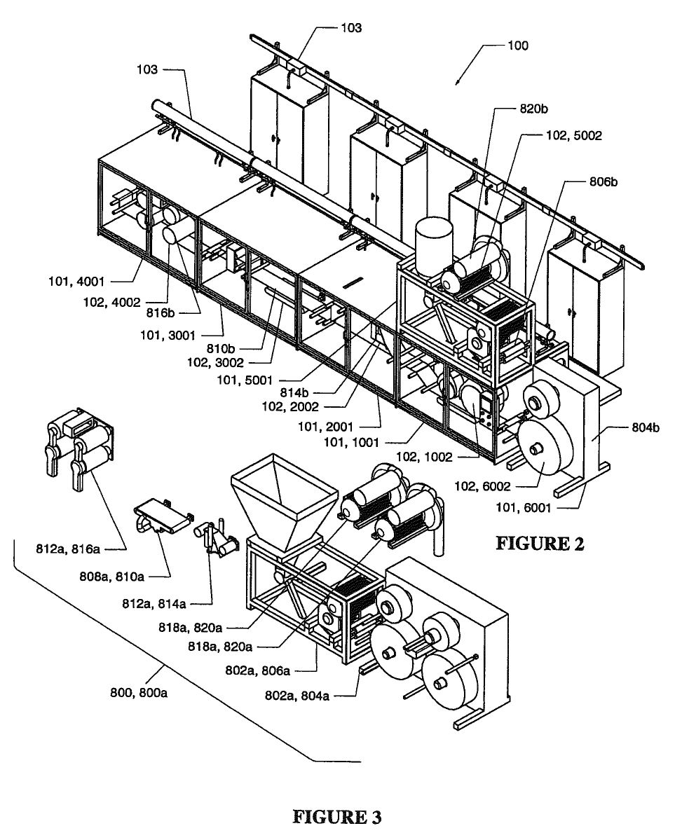

FIGS. 1 and 2 show an embodiment of a converting line 100 including a plurality of process equipment converting modules 101 arranged along a machine direction MD. As shown, five converting modules 101 are positioned on a floor with a sixth converting module 101 stacked on top of one of the converting modules. Although the converting line 100 includes six converting modules 101, it is to be appreciated that other embodiments may include more or less than six converting modules 101. Each converting module may house and/or support a converting mechanism 102 therein. The converting mechanisms 102 may be configured to perform various different manufacturing functions along the converting line 100. The converting line shown in FIGS. 1 and 2 also includes a plurality of accessory service modules 103 arranged along the machine direction. The accessory service modules 103 provide access to various utilities to the converting modules 101 and/or converting mechanisms 102 and may be releasably connected with each other.

As previously mentioned, the converting modules 101 may house various types of converting mechanisms 102. For example, the configuration shown in FIGS. 1 and 2 illustrates a converting line 100 including six converting modules 101 housing and/or supporting six corresponding converting mechanisms 102, which in combination, are adapted to produce a disposable absorbent article in the form of a diaper. Each converting mechanism 102 may be configured to perform various functions of the converting process as materials advance in the machine direction MD through the converting line 100. The following provides a general description of various converting mechanism arrangements that may be utilized with the converting line 100. The following discussion also provides a basis to help illustrate how the converting line operating speed range can be changed with the implementation of a speed kit.

The converting line 100 in FIGS. 1 and 2 is shown in a low speed configuration. In some instances, a low speed configuration may be defined by an operating speed range of about to about 300 to about 600 articles per minute for a baby diaper converter. The converting line 100 includes a first converting module 1001 housing and/or supporting a first converting mechanism 1002. The first converting mechanism 1002 includes a core forming module utilizing a slow speed process wherein a composite web is formed. The composite web passes from the first converting mechanism 1002 to a second converting mechanism 2002 supported by the second converting module 2001. The second converting mechanism 2002 includes a slow speed folding board 814b. As such, the composite web passes through the second converting mechanism 2002 and over the slow speed folding board 814b. From the second converting mechanism 2002, the composite web then passes to a third converting mechanism 3002 supported by a third converting module. The third converting mechanism 3002 includes a compression module and slow speed vacuum conveyor 810b over which the composite web passes. From the third converting module 3002, the composite web then passes to a fourth converting mechanism 4002 supported by a fourth converting module 4001. The fourth converting mechanism 4002 includes an ultrasonic module and through a slow speed ultrasonic treatment device 816b. As shown in FIGS. 1 and 2, the converting line 100 also includes a fifth converting mechanism 5002 supported by a fifth converting module 5001 and a sixth converting mechanism 6002 supported by a sixth converting module 6001. The fifth converting mechanism 5002 includes a slow speed core delivery module 806b and a slow speed vacuum pump 820b. The sixth converting mechanism 6002 includes a slow speed unwind module 804b.

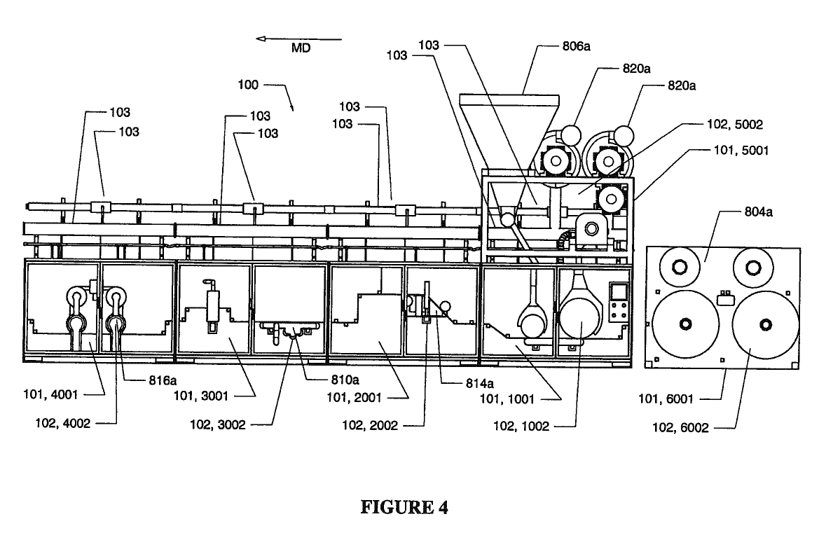

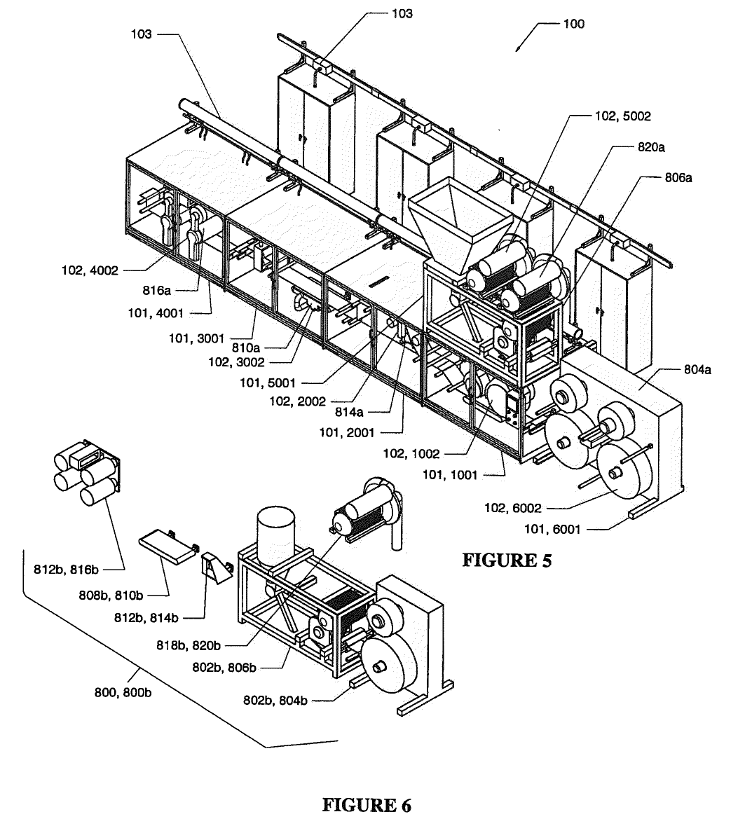

FIG. 3 shows one embodiment of a speed change kit 800 in the form of a high speed kit 800a adapted to be installed on the converting line 100 shown in FIGS. 1 and 2. In particular, by installing the high speed kit 800a, the converting line 100 can be changed from a low speed configuration shown in FIGS. 1 and 2 to a high speed configuration, such as shown in FIGS. 4 and 5. In some instances, a high speed configuration may be defined by an operating speed range of about to about 700 to about 1200 articles per minute for a baby diaper converter. As shown in FIG. 3, the high speed kit 800a includes: two material delivery systems 802a in the form of a high speed unwind 804a and a high speed material core delivery module 806a; a web handling system 808a in the form of a vacuum conveyor 810a; two process transformation apparatuses 812a in the form of a high speed folding board 814a and a high speed ultrasonic treatment device 816a; and a utility system 818a in the form of two vacuum pumps 820a.

When configuring the converting line from the low speed configuration to the high speed configuration, the low speed unwind 804b is removed and replaced with the high speed unwind 804a. In addition, the low speed material core delivery module 806b is removed and replaced with the high speed core material delivery module 806a. Similarly, the low speed folding board 814b is removed and replaced with the high speed folding board 814a. Further, the low speed ultrasonic treatment device 816b is removed and replaced with the high speed ultrasonic treatment device 816a. The low speed vacuum conveyor 810b is also removed and replaced with the high speed vacuum conveyor 810b. Lastly, the low speed vacuum pump 715b is augmented with a second low speed vacuum pump 715a to provide high speed capability.

As previously mentioned, FIGS. 4 and 5 show the converting line 100 of FIGS. 1 and 2 placed in a high speed configuration with the high speed kit 801a from FIG. 3 installed. In the configuration shown in FIGS. 4 and 5, the core forming module of the first converting mechanism 1002 is operated at a high speed wherein a composite web is formed. The composite web passes from the first converting mechanism 1002 to the second converting mechanism 2002, which includes a high speed folding board 814a. As such, the composite web passes through the second converting mechanism 2002 and over the high speed folding board 814a.

From the second converting mechanism 2002, the composite web then passes to the third converting mechanism 3002, which includes the compression module and the high speed vacuum conveyor 810a. From the third converting mechanism 3002, the composite web then passes to the fourth converting mechanism 4002, which includes the high speed ultrasonic treatment device 816a. In addition, the high speed core delivery module 806a has enough capability to support the high speed process and is supplemented by the addition of the second vacuum pump 820a. Further, the sixth converting mechanism 6002 includes a high speed unwind module 804a that has a capability to splice webs together for continuous line operation.

It should be appreciated that the low speed and high speed unit operations for each converting module and/or mechanism may be designed to be interchangeably mountable in the respective modules. For example, the low speed unwind module 804b may be assembled with the core forming module interchangeably with the high speed unwind module 804a; and the low speed core material supply module 806b may be assembled with the core forming module interchangeably with the high speed core material supply module 806a; and the second vacuum pump 820a may be mounted to the material supply module 2001 in reserved space; and the slow speed folding board 814b may be mounted in the second module 2001 interchangeably with the high speed folding board 814a; and the low speed vacuum conveyor 810b may be mounted in the third converting module 3001 interchangeably with the high speed vacuum conveyor 810a; and the low speed ultrasonic treatment device 816b may be mounted in the fourth converting module 4001 interchangeably with the high speed ultrasonic device 816a. Arrangements of such interchangeably mounted components may help provide for relatively rapid and low cost conversions of one converting line configuration to another. Further, a specific group of components and/or modules may be gathered together to form a kit containing all the necessary items for such a conversion.

While the above discussion of FIGS. 1-5 provided an example of how the converting line 100 may be changed from a low speed configuration to a high speed configuration by implementing a high speed kit 800a into the converting line, it is to be appreciated that a converting line can be changed from a high speed configuration to a low speed configuration by implementing a low speed kit 800b, such as shown in FIG. 6. The low speed kit 800b shown in FIG. 6 includes: two material delivery systems 802b in the form of a low speed unwind 804b and a low speed material core delivery module 806b; a web handling system 808b in the form of a low speed vacuum conveyor 810b; two process transformation apparatuses 812b in the form of a low speed folding board 814b and a low speed ultrasonic treatment device 816b; and a utility system 818b in the form of a single vacuum pump 820b.

In light of the above discussion, it is to be appreciated that a converting line including a plurality of absorbent article converting mechanisms adapted to operate at a first speed range can be modified or reconfigured with the implementation of a speed change kit. For example, the plurality of absorbent article converting mechanisms can be configured from a first configuration to a second configuration by modifying the plurality of absorbent article converting mechanisms to include a speed change kit. When in the first configuration, the plurality of absorbent article converting mechanisms operate to produce absorbent articles at a first speed range. And when in the second configuration, the plurality of absorbent article converting mechanisms operate to produce absorbent articles at a second speed range different from the first speed range. The first speed range may be defined by a first minimum speed and a first maximum speed greater than the first minimum speed, and the second speed range may be defined by a second minimum speed and a second maximum speed greater than the second minimum speed. In some instances, the first and second speed ranges can be mutually exclusive. For example, the second minimum speed may be greater than the first maximum speed. In other instances, the first and second speed ranges may overlap. For example, the second minimum speed may be greater than the first minimum speed and less than the first maximum speed. And the second maximum speed may be greater than the first maximum speed.

It is to be appreciated that the speed change kits and methods disclosed herein may be utilized with various different types and aspects of methods and apparatuses relating to converting lines, such as, for example, described in the U.S. patent application identified by Attorney Docket No. 11399, entitled “RECONFIGURABLE CONVERTING LINE FOR FABRICATING ABSORBENT ARTICLES,” filed on Aug. 20, 2009; U.S. patent application identified by Attorney Docket No. 11397, entitled “MODULAR CONVERTING LINE FOR FABRICATING ABSORBENT ARTICLES,” filed on Aug. 20, 2009; U.S. patent application identified by Attorney Docket No. 11395, entitled “SYSTEMS AND METHODS FOR CONTINUOUS DELIVERY OF WEB MATERIALS,” filed on Aug. 20, 2009; and U.S. patent application identified by Attorney Docket No. 11396, entitled “FLEXIBLE MANUFACTURING SYSTEMS AND METHODS,” filed on Aug. 20, 2009, all of which are incorporated by reference herein.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A system for fabricating disposable absorbent articles comprising:
a plurality of converting modules, each converting module defining an interior space;
a plurality of absorbent article converting mechanisms, each converting mechanism arrange in the interior space of each converting module; and
a speed kit;
wherein the plurality of absorbent article converting mechanisms can be configured from a first configuration to a second configuration by modifying the plurality of absorbent article converting mechanisms to include the speed kit;
wherein in the first configuration, the plurality of absorbent article converting mechanisms operate to produce absorbent articles at a first speed range; and
wherein in the second configuration, the plurality of absorbent article converting mechanisms operate to produce absorbent articles at a second speed range different from the first speed range.

2. The system of claim 1, wherein:
the first speed range is defined by a first minimum speed and a first maximum speed greater than the first minimum speed;
the second speed range is defined by a second minimum speed and a second maximum speed greater than the second minimum speed.

3. The system of claim 2, wherein the second minimum speed is greater than the first maximum speed.

4. The system of claim 2, wherein the second minimum speed is greater than the first minimum speed and less than the first maximum speed.

5. The system of claim 4, wherein the second maximum speed is greater than the first maximum speed.

6. The system of claim 1, further comprising at least one material delivery system selected from the group consisting of: a hot melt glue system, an AGM feed system, and a web delivery system.

7. The system of claim 1, further comprising at least one web handling system selected from the group consisting of: a vacuum conveyor, a web idler, a web guider, and a scrap product conveyor.

8. The system of claim 1, further comprising at least one process transformation apparatus selected from the group consisting of: a folding device; a stretch activation unit; a cut and slip unit; a discrete component applicator; a cutting device; and a bonding unit.

9. The system of claim 1, further comprising at least one utility system selected from the group consisting of: a noise abatement enclosure; a vacuum fan; a vacuum pump; and a chilling unit.

10. A system for fabricating disposable absorbent articles comprising:
a plurality of converting modules, each converting module defining an interior space;
a plurality of absorbent article converting mechanisms, each converting mechanism disposed in the interior space of each converting module;
wherein the plurality of absorbent article converting mechanisms can be configured from a first configuration to a second configuration by modifying the plurality of absorbent article converting mechanisms to include a speed kit, the speed kit comprising:
at least one material delivery system selected from the group consisting of: a hot melt glue system, a particle feed system; and a web delivery system;
at least one web handling system selected from the group consisting of: a vacuum conveyor, a web idler, a web guider, and a scrap product conveyor;
at least one process transformation apparatus selected from the group consisting of: a folding device, a stretch activation unit, a cut and slip unit, a discrete component applicator, a cutting device, and a bonding unit;
at least one utility system selected from the group consisting of: a noise abatement enclosure, a vacuum fan, a vacuum pump, and a chilling unit; and
wherein in the first configuration, the plurality of absorbent article converting mechanisms operate to produce absorbent articles at a first speed range; and
wherein in the second configuration, the plurality of absorbent article converting mechanisms operate to produce absorbent articles at a second speed range different from the first speed range.

11. The system of claim 10, wherein:
the first speed range is defined by a first minimum speed and a first maximum speed greater than the first minimum speed;
the second speed range is defined by a second minimum speed and a second maximum speed greater than the second minimum speed.

12. The system of claim 11, wherein the second minimum speed is greater than the first maximum speed.

13. The system of claim 11, wherein the second minimum speed is greater than the first minimum speed and less than the first maximum speed.

14. The system of claim 13, wherein the second maximum speed is greater than the first maximum speed.

15. A method of reconfiguring a converting line adapted to operate at a first speed range to operate at a second speed range different from the first speed range, wherein the first speed range is defined by a first minimum speed and a first maximum speed greater than the first minimum speed and wherein the second speed range is defined by a second minimum speed and a second maximum speed greater than the second minimum speed, the method comprising the steps of:
removing at least one of a first material delivery system, a first web handling system, a first process transformation apparatus, and a utility system from the converting line; and
installing at least one of a second material delivery system, a second web handling system, a second process transformation apparatus, and a second utility system on the converting line, wherein the second material delivery system is selected from the group consisting of: a hot melt glue system, an AGM feed system; and a web delivery system; wherein the second web handling system is selected from the group consisting of: a vacuum conveyor, a web idler, a web guider, and a scrap product conveyor; wherein the second process transformation apparatus is selected from the group consisting of: a folding device, a stretch activation unit, a cut and slip unit, a discrete component applicator, a cutting device, and a bonding unit; and wherein the second utility system is selected from the group consisting of: a noise abatement enclosure, a vacuum fan, a vacuum pump, and a chilling unit.

16. The system of claim 15, wherein the second minimum speed is greater than the first maximum speed.

17. The system of claim 15, wherein the second minimum speed is greater than the first minimum speed and less than the first maximum speed.

18. The system of claim 17, wherein the second maximum speed is greater than the first maximum speed.
